(19) United States
(12) Patent Application Publication
(10) Pub. No.: US 2026/0067453 A1
(43) Pub. Date: Mar. 5, 2026

(54) METHOD AND DEVICE FOR VIDEO CODING USING CC-ALF BASED ON NONLINEAR CROSS-COMPONENT RELATIONSHIPS

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jung Kyung Lee, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 19/104,473

(22) PCT Filed: Jul. 20, 2023
(86) PCT No.: PCT/KR2023/010509

§ 371 Date: Feb. 18, 2025

(30) Foreign Application Priority Data
Aug. 18, 2022 (KR) 10-2022-0103224
Jul. 18, 2023 (KR) 10-2023-0093234

(51) Int. Cl. H04N 19/117; H04N 19/186; H04N 19/82

(52) U.S. Cl. CPC H04N 19/117; H04N 19/186; H04N 19/82

(57) ABSTRACT

A method and an apparatus are disclosed for video coding CC-ALF based on a nonlinear cross-component relation. A video decoding device obtains a reconstructed frame that is an output of a sample adaptive offset (SAO) filter and generates an adaptive loop filter output (ALF output) by inputting the reconstructed frame into an adaptive loop filter (ALF). The ALF output includes a luma ALF output and a chroma ALF output. The video decoding device generates corrected values of a chroma component by inputting the luma ALF output into a nonlinear cross-component ALF (nonlinear CC-ALF) and generates an enhanced chroma ALF output by summing the corrected values of the chroma component and the chroma ALF output.

### CROSS-REFERENCE TO RELATED APPLICATIONS

This is a U.S. national stage of International Application No. PCT/KR2023/010509, filed on Jul. 20, 2023, which claims priority to Korean Patent Application No. 10-2022-0103224 filed on Aug. 18, 2022, and Korean Patent Application No. 10-2023-0093234, filed on Jul. 18, 2023, the entire contents of each of which are hereby incorporated herein by reference.

### TECHNICAL FIELD

The present disclosure relates to a video coding method and an apparatus using CC-ALF based on a nonlinear cross-component relation.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

The cross-component adaptive loop filter (CC-ALF), a component of the in-loop filter of the VVC, corrects the chroma component in parallel with the adaptive loop filter (ALF) based on the correlation between the current chroma sample and its corresponding luma sample. The conventional CC-ALF for when generating the corrected values of the chroma samples, applies a linear filtering operation to the inputted luma samples. Therefore, to increase video coding efficiency and enhance video quality, there is a need to consider a method of generating the corrected values of the chroma sample more efficiently.

### SUMMARY

The present disclosure seeks to provide a video coding method and an apparatus for improving chroma components by using linear modeling and nonlinear modeling when applying in-loop filtering to reconstructed video signals.

At least one aspect of the present disclosure provides a method of filtering a reconstructed frame by a video decoding device. The method includes obtaining the reconstructed frame that is an output of a sample adaptive offset (SAO) filter. The method also includes generating an adaptive loop filter output (ALF output) by inputting the reconstructed frame into an adaptive loop filter (ALF). Here, the ALF output including a luma ALF output and a chroma ALF output. The method also includes generating corrected values of a chroma component by inputting the luma ALF output into a nonlinear cross-component ALF (nonlinear CC-ALF). The method also includes generating an enhanced chroma ALF output by summing the corrected values of the chroma component and the chroma ALF output.

Another aspect of the present disclosure provides a method of filtering a reconstructed frame by a video encoding device. The method includes obtaining the reconstructed frame that is an output of a sample adaptive offset (SAO) filter. The method also includes generating an adaptive loop filter output (ALF output) by inputting the reconstructed frame into an adaptive loop filter (ALF). Here, the ALF output including a luma ALF output and a chroma ALF output. The method also includes generating corrected values of a chroma component by inputting the luma ALF output into a nonlinear cross-component ALF (nonlinear CC-ALF). The method also includes generating a first enhanced chroma ALF output by summing the corrected values of the chroma component and the chroma ALF output.

Yet another aspect of the present disclosure provides a computer-readable recording medium storing a bitstream generated by a video encoding method. The video encoding method includes obtaining a reconstructed frame that is an output of a sample adaptive offset (SAO) filter. The video encoding method also includes generating an adaptive loop filter output (ALF output) by inputting the reconstructed frame into an adaptive loop filter (ALF). Here, the ALF output including a luma ALF output and a chroma ALF output. The video encoding method also includes generating corrected values of a chroma component by inputting the luma ALF output into a nonlinear cross-component ALF (nonlinear CC-ALF). The video encoding method also includes and generating an enhanced chroma ALF output by summing the corrected values of the chroma component and the chroma ALF output.

As described above, the present disclosure provides a video coding method and an apparatus for improving chroma components by using linear modeling and nonlinear modeling when applying in-loop filtering to reconstructed video signals. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the configuration of an adaptive loop filter (ALF).

FIG. 7 is a diagram illustrating the application of a cross-component adaptive loop filter (CC-ALF).

FIG. 8 is a diagram illustrating the configuration of a CC-ALF.

FIG. 9 is a flowchart of a method of filtering a reconstructed frame by a video encoding device, according to at least one embodiment of the present disclosure.

FIG. 10 is a flowchart of a method of filtering a reconstructed frame by a video decoding device, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

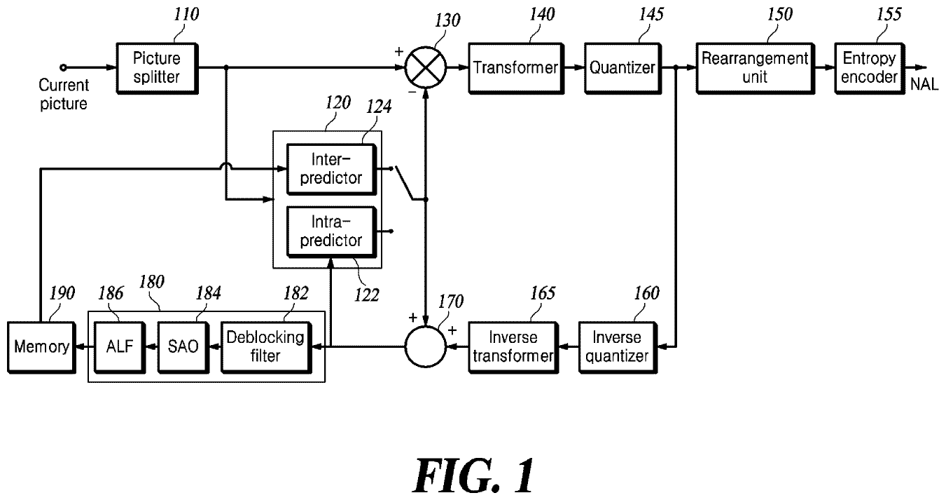

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

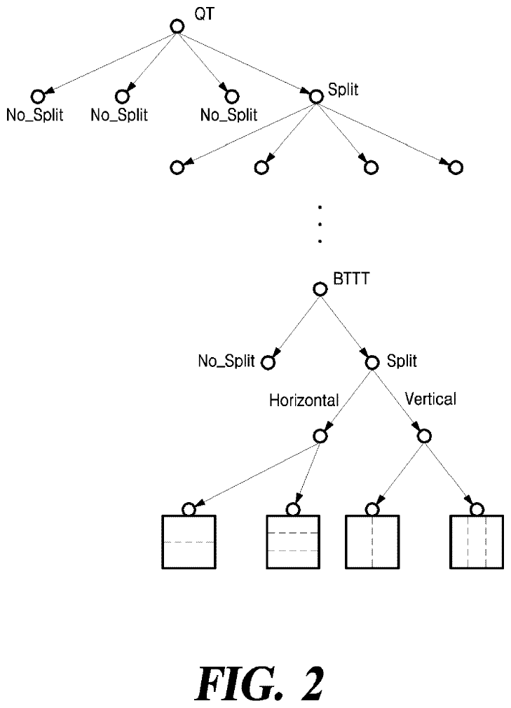

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

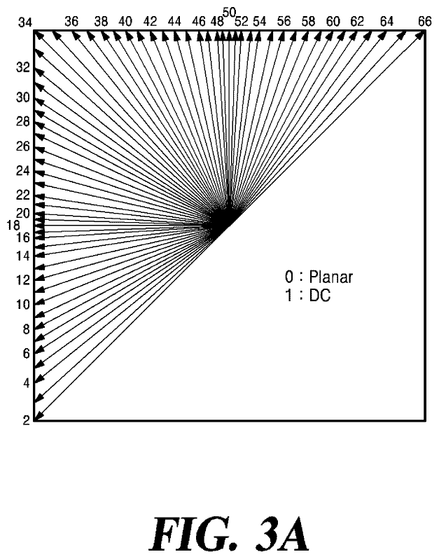

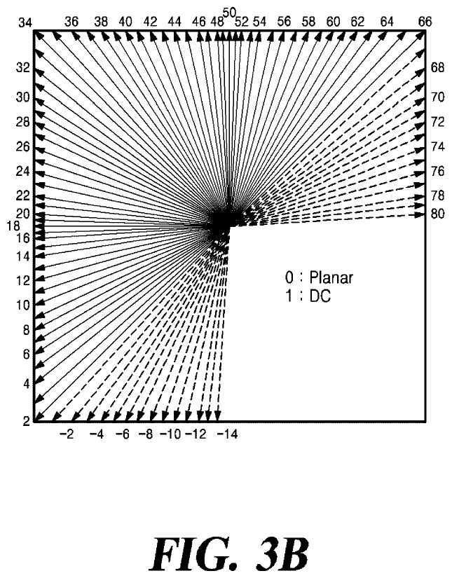

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

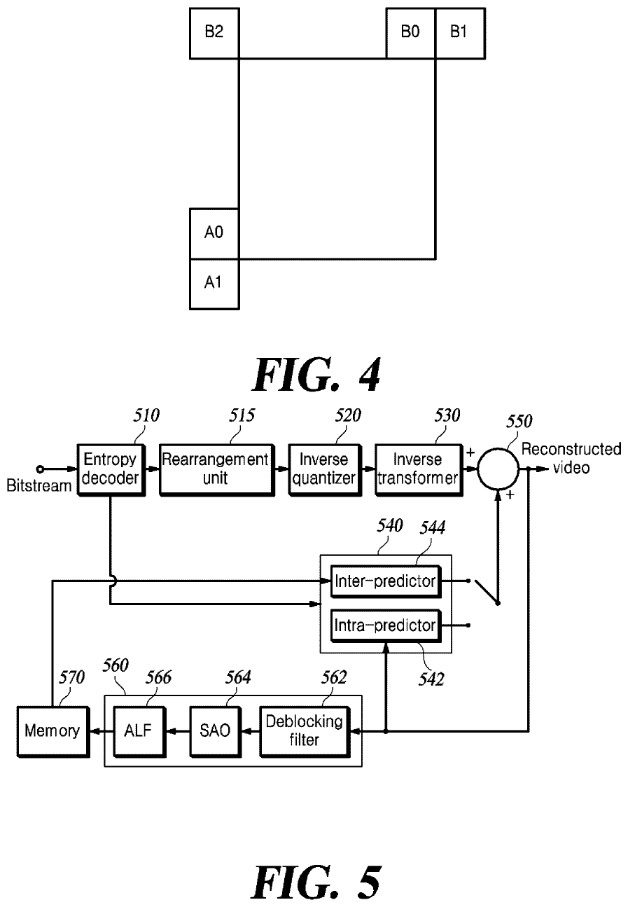

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for improving chroma components by using linear modeling and nonlinear modeling when applying in-loop filtering to reconstructed video signals.

The following embodiments may be performed by the loop filter unit 180 in the video encoding device. The following embodiments may also be performed by the loop filter unit 560 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

The following embodiments are described with reference to the video decoding device but may be implemented in the same or similar manner in the video encoding device.

### I. In-Loop Filter

As described above, to remove artifacts remaining after compression, in-loop filters including the deblocking filter (182 or 562), SAO filter (184 or 564), ALF (186 or 566), and luma mapping and chroma sampling (LMCS) are used. Within the encoding and decoding loop, the in-loop filters are applied to the reconstructed image in the order of LMCS, deblocking filter, SAO filter, and ALF, and the output picture is stored in a decoded picture buffer (DPB) in the memory (190 or 570).

As described above, the deblocking filter (182 or 562) and SAO filter (184 or 564) are used to remove blocking artifacts and ringing artifacts as in HEVC.

Compared to HEVC, ALF (186 or 566) and LMCS are new in-loop filters added to VVC. The ALF (186 or 566) utilizes filter coefficients determined based on the Wiener-Hopf equation to reduce the mean square error (MSE) between the original samples and reconstructed samples. The LMCS adjusts the dynamic range of pixel values in the image to improve the objective quality of the reconstructed image.

### II. Adaptive Loop Filter (ALF)

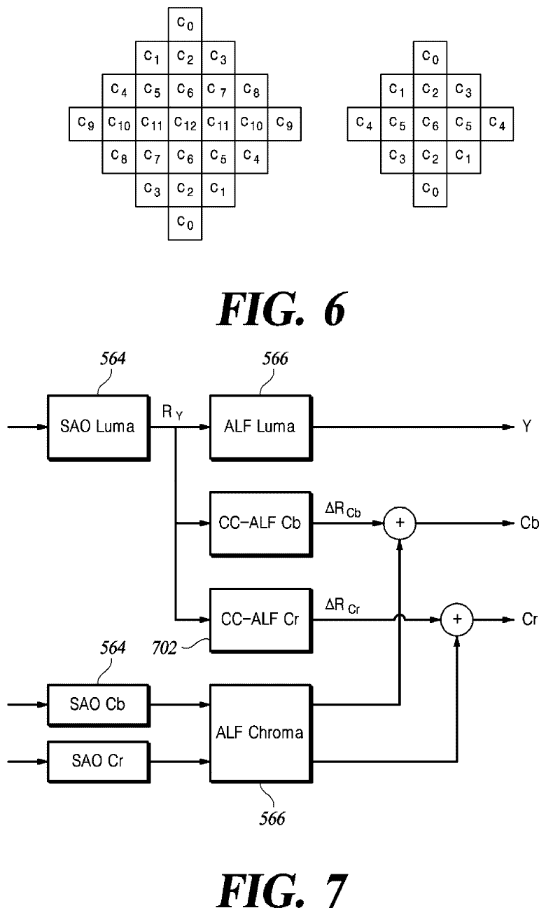

The ALF (186 or 566) of the VVC utilizes an adaptive linear filter based on the Wiener-Hopf equation to approximate the reconstructed video frame to the original. The video encoding device uses the output samples of the SAO 184 to calculate the filter coefficients of the ALF 186 based on rate-distortion optimization and transmits the filter coefficients to the video decoding device. The ALF (186 or 566) as illustrated in FIG. 6 are configured as 7×7 diamond shapes and 5×5 diamond shapes for luma and chroma samples, respectively. The filter shape and size may be determined by considering a tradeoff between coding efficiency and computational complexity. For example, the computational complexity of the ALF (186 or 566) may be reduced by using a symmetric FIR filter.

To derive the filter coefficients cᵢ illustrated in FIG. 6, samples are utilized at their relevant locations. The filtered sample I(x,y) at the current position (x,y) may be calculated as shown in Equation 1, subject to a precision operation of 7 bits.

$$\tilde{I} ( x , y ) = I ( x , y ) + [ ( {\sum }_{i = 0}^{N - 2} {c}_{i} {r}_{i} + 64 ) ≫ 7 ] \qquad [ Equation 1 ]$$

Herein, rᵢ is the difference between the current sample and its adjacent samples, calculated according to Equation 2.

$${r}_{i} = min ( {b}_{i} , max ( - {b}_{i} , I ( x + {x}_{i} , y + {y}_{i} ) - I ( x , y ) ) ) + min ( {b}_{i} , max ( - {b}_{i} , I ( x - {x}_{i} , y - {y}_{i} ) - I ( x , y ) ) ) \qquad [ Equation 2 ]$$

Here, bᵢ is a clipping parameter.

The ALF (186 or 566) utilizes up to 25 sets of filter coefficients for the luma component and applies filter coefficients to a 4×4 subblock. Based on the gradient information of the local blocks computed by using the Laplacian filter, the 4×4 subblocks are categorized into one of 25 classes. Specifically, the classification index for a class is derived from the combination of the five directional attributes, which represent the intensity and direction of the texture components, and the five activity attributes of the subblock. In addition, geometric transforms such as 90-degree rotation, diagonalization, and verticalization may be applied to the filter coefficients before filtering. By using geometric transforms to account for different directions, a wider variety of block characteristics may be processed by using fewer sets of filter coefficients.

Besides the subblock level, the decision to apply may be made at the CTU level. For the chroma component, up to eight filters are used at the CTU level. The chroma ALF may be enabled only if the luma ALF is enabled at that level.

Meanwhile, an adaptation parameter pet (APS) is used to convey the ALF filter parameters, including a set of filter coefficients. As described above, up to 25 sets of filter coefficients may be calculated for the luma component and up to 8 sets of filter coefficients may be calculated for the chroma component. If the same ALF coefficients are used for different slices, the index of the reference APS may be signaled instead of redundantly retransmitting the same ALF coefficients.

### III. Cross-Component ALF (CC-ALF)

In video applications such as High-Dynamic Range (HDR) and Wide Color Gamut (WCG), the reconstruction of video color is critical. The Cross-Component Adaptive Loop Filter (CC-ALF) uses the correlation between the current chroma sample and the positionally corresponding luma sample to modify the chroma sample in parallel with the ALF.

FIG. 7 is a diagram illustrating the application of a cross-component ALF.

To generate the corrected values of the chroma samples from the inputted luma samples, a CC-ALF 702 is provided to perform a linear filtering operation, as illustrated in FIG. 7. The linear filtering operation uses the luma samples (R_{Y}( )) as input to generate a correlation value (ΔRᵢ( ) with each chroma sample (i∈{Cb, Cr}), as shown in Equation 3.

$$Δ {R}_{i} ( x , y ) = {\sum }_{( {x}_{0} , {y}_{0} ) ∈ {S}_{i}} {R}_{Y} ( {x}_{C} + {x}_{0} , {y}_{C} + {y}_{0} ) {c}_{i} ( {x}_{0} , {y}_{0} ) \qquad [ Equation 3 ]$$

Here, (x, y) is the position of each chroma sample, and (x_{c}, y_{c}) is the position of the luma sample corresponding to (x, y). (x₀, y₀) denotes a filter support offset around (x_{c}, y_{c}), and cᵢ(x₀, y₀) denotes a filter coefficient. Sᵢ denotes the target region to filter with respect to the luma component. The correlation value is then utilized as a corrected value to enhance the output of the chroma ALF 566, as illustrated in FIG. 7.

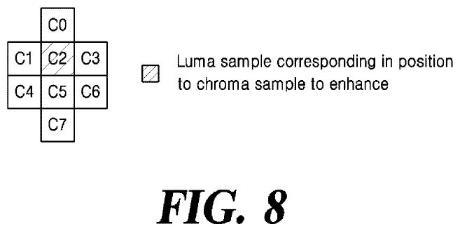

In one example, a 3×4 diamond-shaped high-pass filter, as illustrated in FIG. 8, may be applied to the luma samples to generate a corrected value. To generate the corrected value for each chroma sample, the luma samples are used, which have passed through the SAO filter 564 corresponding to each chroma sample position.

The video encoding device may determine four sets of filter coefficients of the CC-ALF 702 for each chroma component. Unlike typical ALFs, the CC-ALF filter has coefficients that are not subject to symmetry constraints, but the coefficients have the following characteristics. First, the sum of the CC-ALF coefficients is zero. Second, the absolute value of the CC-ALF coefficients is either 0 or a power of 2.

The video encoding device signals one of the four sets for each chroma component on a CTU basis. The CC-ALF filter coefficients may be transmitted along with the ALF parameters of the APS. For the CC-ALF 702 to be used at the sequence level, the ALF 566 also needs to be used in that sequence. Similarly, for the CC-ALF 702 to be used at the slice or picture level, the ALF 566 also needs to be used in that slice or picture.

On the other hand, to save line buffers given the filter sizes of the luma and chroma ALFs 566, the virtual boundaries of luma and chroma are formed four and two lines above the CTU boundary, respectively. When CC-ALF 702 is applied to a 4:2:0 chroma format, there is no difficulty with the alignment of the luma and chroma line buffers based on the location of the virtual boundaries. However, when CC-ALF (702) is applied to a 4:2:2 or 4:4:4 chroma format, the difference in position of the virtual boundary causes misalignments between the luma and chroma line buffers at the 3rd and 4th rows above the CTU boundary. Therefore, against the 4:2:2 and 4:4:4 chroma formats, CC-ALF (702) is not applied to the samples in the 3rd and 4th rows above the CTU boundary.

The following embodiments are described with respect to the video decoding device but may be implemented in the same or similar manner in the video encoding device.

### IV. Embodiments According to the Present Disclosure

Cross-component linear model prediction (CCLM) is a technique for predicting chroma samples by identifying correlations between luma components and chroma components.

When CCLM mode is applied for intra prediction of the current chroma block, the video decoding device determines a region in the luma image corresponding to the current chroma block, wherein such a luma image is referred to as the ‘corresponding luma region’ hereinafter. Utilized for prediction of the linear model may be the left reference pixels and the top reference pixels of the corresponding luma region, and the left reference pixels and the top reference pixels of the target chroma block. Hereinafter, the left reference pixels and the top reference pixels are commonly referred to as reference pixels, neighboring pixels, or adjacent pixels. Additionally, reference pixels in the chroma channel are denoted as chroma reference pixels, and reference pixels in the luma channel are denoted as luma reference pixels.

In CCLM prediction, a prediction block that is a predictor of the target chroma block is generated by deriving a linear model between the reference pixels in the corresponding luma region and the reference pixels in the chroma block and then by applying the linear model to the reconstructed pixels in the corresponding luma region. For example, the linear model parameters α and β may be derived by the Linear Minimum Mean Square Error (LMMSE) method from samples of an adjacent line in the current block. Alternatively, used for derivation of the linear model may be four pairs of pixels from pixels in the neighboring pixel lines of the current chroma block combined with pixels in the corresponding luma region. The video decoding device may derive α and β representing the linear model, as shown in Equation 4, from the four pairs of pixels.

$$α = \frac{{Y}_{b} - {Y}_{a}}{{X}_{b} - {X}_{a}} , β = {Y}_{a} - α \cdot {X}_{a} \qquad [ Equation 4 ]$$

Here, for the corresponding luma pixels of the four pairs of pixels, Xa and Xb represent the average of the two minimum values and the average of the two maximum values, respectively. Further, for the chroma pixels, Y, and Yb represent the average value of the two minimum values and the average value of the two maximum values, respectively. Then, the video decoding device may use the linear model to generate a predictor pred_{C}(i.j) of the current chroma block from the pixel values rec′_{L}(i.j) of the corresponding luma region, as shown in Equation 5.

$$p r e {d}_{C} ( i , j ) = α \cdot {rec}_{L}^{′} ( i , j ) + β \qquad [ Equation 5 ]$$

As described above, the CCLM mode is divided into three modes, CCLM_LT, CCLM_L, and CCLM_T, depending on the location of the neighboring pixels used in the derivation of the linear model. CCLM_LT mode uses two pixels in each direction from the neighboring pixels adjacent to the left and top of the current chroma block. CCLM_L mode uses four pixels from the neighboring pixels adjacent to the left of the current chroma block. Finally, CCLM_T mode utilizes four pixels from the neighboring pixels adjacent to the top of the current chroma block.

As described above, CCLM prediction assumes a linear correlation between the luma components and chroma components. The present disclosure describes a correlation between the luma components and chroma components with a nonlinear model added in addition to the linear model.

An example use of a nonlinear model in addition to a linear model to predict a chroma sample by using a luma sample may be expressed as shown in Equation 6.

$$p r e {d}_{C} ( i , j ) = {α}_{0} \cdot ( ( {( {rec}_{L}^{′} ( i , j ) )}^{2} + midValue ) ≫ bitDpeth ) + {α}_{1} \cdot {rec}_{L}^{′} ( i , j ) + {α}_{2} \cdot midVlaue \qquad [ Equation 6 ]$$

Here, the parameters α₀, α₁, and α₂ of the nonlinear model may be derived from adjacent reconstructed samples. For example, for a video using 10 bits, a bit depth bitDepth is set to 10, and a median value midValue is set to 512.

As described above, the CC-ALF 702 proceeds with filtering by deriving a corrected value ΔR based on the association between the luma component and the chroma component, and by adding the derived corrected value to the output of the conventional chroma ALF 566, as illustrated in FIG. 7.

The CC-ALF 702 corrects the chroma sample in parallel with the ALF by using the correlation between the current chroma sample and the luma sample at that location. To generate the corrected values of the chroma samples from the inputted luma samples, the CC-ALF 702 performs a linear filtering operation, as illustrated in FIG. 7. The linear filtering operation uses the luma samples (R_{Y}( ) as input to generate a correlation value (ΔRᵢ( ) with each chroma sample (i∈{Cb, Cr}), as shown in Equation 7.

$$Δ {R}_{i} ( x , y ) = {\sum }_{( {x}_{0} , {y}_{0} ) ∈ {S}_{i}} {R}_{Y} ( {x}_{C} + {x}_{0} , {y}_{C} + {y}_{0} ) {c}_{i} ( {x}_{0} , {y}_{0} ) \qquad [ Equation 7 ]$$

Here, (x, y) is the position of each chroma sample, and (x_{c}, y_{c}) is the position of the luma sample corresponding to (x, y). (x₀, y₀) denotes the filter support offset around (x_{c}, y_{c}), and cᵢ(x₀, y₀) denotes the filter coefficient. Sᵢ represents the target region to filter in the luma component.

To efficiently remove artifacts, the nonlinear CC-ALF according to the present embodiment uses nonlinear modeling (NM) of the luma component to derive a corrected value ΔR, as shown in Equation 8.

$$Δ {R}_{i} ( x , y ) = {\sum }_{( {x}_{0} , {y}_{0} ) ∈ {S}_{i}} \{ NM of {R}_{Y} ( {x}_{C} + {x}_{0} , {y}_{C} + {y}_{0} ) \} {c}_{i} ( {x}_{0} , {y}_{0} ) \qquad [ Equation 8 ]$$

Here, R_{Y} denotes a reconstructed sample of the luma component. (x, y) is the position of each chroma sample, and (x_{c}, y_{c}) is the position of the luma sample corresponding to (x, y). (x₀, y₀) denotes the filter support offset around (x_{c}, y_{c}), and c; (x₀, y₀) denotes the filter coefficient. Sᵢ denotes the target region to filter in the luma component.

The nonlinear CC-ALF uses a nonlinear model with respect to the luma samples within the target region to filter to generate nonlinear modeled values of the luma samples. The nonlinear CC-ALF may then generate a corrected value ΔR based on the product of the nonlinear modeled values and the filter coefficients of the nonlinear CC-ALF.

The nonlinear modeling may be performed in one of the following methods.

In one example, the nonlinear modeling may use a polynomial model, as shown in Equation 9.

$$N M = {α}_{n} \cdot {( {R}_{Y} ( {x}_{C} + {x}_{0} , {y}_{C} + {y}_{0} ) )}^{n} + {α}_{n - 1} \cdot {( {R}_{Y} ( {x}_{C} + {x}_{0} , {y}_{C} + {y}_{0} ) )}^{n - 1} + … + {α}_{1} \cdot ( {R}_{Y} ( {x}_{C} + {x}_{0} , {y}_{C} + {y}_{0} ) ) + {α}_{0} \qquad [ Equation 9 ]$$

As another example, a Michaelis-Menten hyperbolic model may be utilized, as shown in Equation 10.

$$NM = \frac{{R}_{Y} ( {x}_{C} + {x}_{0} , {y}_{C} + {y}_{0} ) + {α}_{0}}{1 + {α}_{1} + {R}_{Y} ( {x}_{C} + {x}_{0} , {y}_{C} + {y}_{0} )} \qquad [ Equation 10 ]$$

As yet another example, a model based on the Fourier transform may be utilized, as shown in Equation 11.

$$NM = {α}_{1} cos ( {R}_{Y} ( {x}_{C} + {x}_{0} , {y}_{C} + {y}_{0} ) + {α}_{0} ) \qquad [ Equation 11 ]$$

As yet another example, an exponential function model may be utilized, as shown in Equation 12.

$$N M = {e}^{{R}_{Y} ( {x}_{C} + {x}_{0} , {y}_{C} + {y}_{0} )} + {α}_{0} \qquad [ Equation 12 ]$$

In Equation 9 through Equation 12, R_{Y} denotes a reconstructed sample of the luma component. (x_{c}, y_{c}) is the position of the luma sample corresponding to the position (x, y) of each chroma sample. (x₀, y₀) denotes the filter support offset around (x_{c}, y_{c}). Furthermore, αⱼ denotes the coefficients of the nonlinear model of the luma component.

In one example, with the nonlinear model incorporated as described above, the CC-ALF 702 may be derived as a sum of a linear model and a nonlinear model. In other words, the CC-ALF 702 may be a linear model, a nonlinear model, or a combination of a linear model and a nonlinear model.

Alternatively, the nonlinear CC-ALF and the linear CC-ALF may be used adaptively. For example, in the polynomial-based nonlinear model shown in Equation 9, the nonlinear CC-ALF may be transformed into a linear CC-ALF by changing all values except α₁ and do associated with the linear coefficients to zero.

The nonlinear CC-ALF, like the conventional CC-ALF, may have a diamond-shaped target region to filter of size 3×4.

Thus, when the nonlinear CC-ALF is applied to a 4:2:2 or 4:4:4 chroma format, the luma and chroma line buffers are not aligned with each other in the third and fourth rows above the CTU boundary due to the difference in position of the virtual boundary. Therefore, for the 4:2:2 and 4:4:4 chroma formats, the nonlinear CC-ALF may not be applied to the samples in the third and fourth rows above the CTU boundary.

To indicate whether or not nonlinear CC-ALF is applied, the video encoding device may signal a flag (hereinafter referred to as a ‘nonlinear CC-ALF flag’) to the video decoding device. The application or non-application of the nonlinear CC-ALF may be determined at the sequence, picture, sub-picture, slice, tile, and/or coding tree unit (CTU) level.

For the nonlinear CC-ALF to be used at a particular application level, the linear CC-ALF 702 and ALF 566 also need to be used at that level. For example, for the nonlinear CC-ALF to be used at a slice level, the ALF 566 also needs to be used at that slice. In terms of flags, the nonlinear CC-ALF flags may be signaled and parsed, if both the flag indicating whether or not the ALF 566 is applied (hereinafter referred to as the ‘ALF flag’) and the flag indicating whether or not the linear CC-ALF 702 is applied (hereinafter referred to as the ‘CC-ALF flag’) are true. Thus, if the nonlinear CC-ALF Flag is true, the nonlinear CC-ALF may be applied. On the other hand, if the nonlinear CC-ALF flag is false, the CC-ALF flag may determine whether linear CC-ALF is applied.

The nonlinear CC-ALF filter coefficients may be transmitted in the form of an Adaptation Parameter Set (APS). Alternatively, a fixed filter may be used that is predefined by an agreement between the video encoding device and the video decoding device. Alternatively, the same filter as used by the linear CC-ALF 702 may be used.

As another example, the video encoding device may determine which filter to use, a filter configured according to the APS or a fixed filter, and then may signal the determined index to the video decoding device along with the filter coefficients according to the APS.

The video encoding device may also signal the coefficients of the nonlinear model of the luma component along with the filter coefficients. In this case, if an is zero, all ak under n<k may all be set to zero.

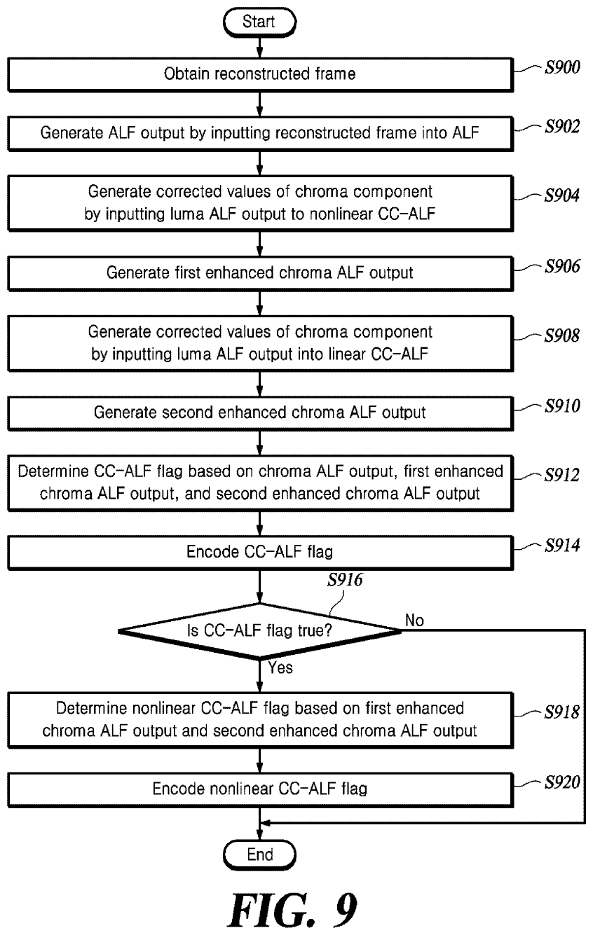

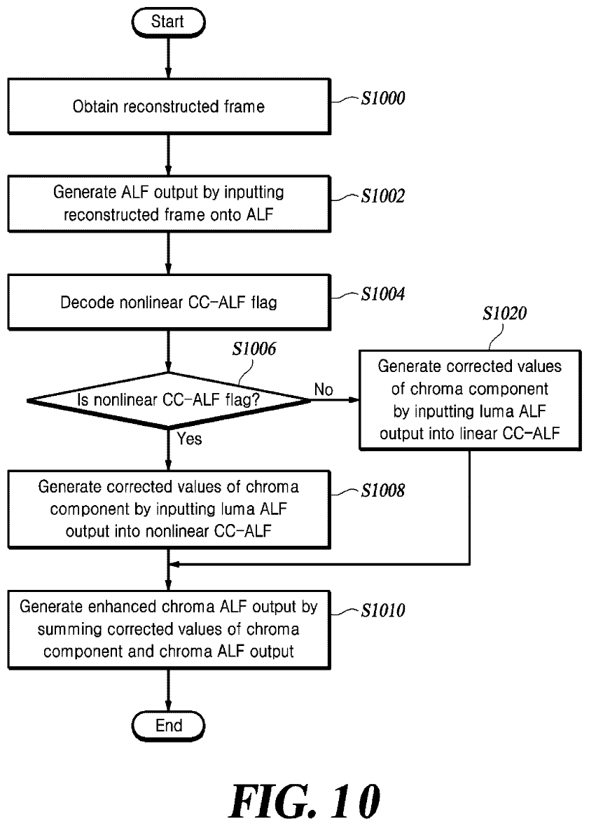

Referring now to FIGS. 9 and 10, methods of filtering a reconstructed frame by using a nonlinear CC-ALF are be described.

FIG. 9 is a flowchart of a method of filtering reconstructed frames by the video encoding device, according to at least one embodiment of the present disclosure.

The example of FIG. 9 illustrates when the ALF flag is set to true.

The video encoding device obtains the reconstructed frame (S900). Here, the reconstructed frame is the output of the SAO filter 184.

The video encoding device inputs the reconstructed frame into the ALF to generate an ALF output (S902). Here, the ALF output includes a luma ALF output and a chroma ALF output.

The video encoding device inputs the luma ALF output to the nonlinear CC-ALF to generate corrected values of the chroma component (S904).

The video encoding device generates nonlinear modeled values of the luma samples by using a nonlinear model with respect to the luma samples within the target region to filter. The video encoding device may then generate corrected values based on a product of the nonlinear modeled values and the filter coefficients of the nonlinear CC-ALF.

The video encoding device sums the corrected values of the chroma components and the chroma ALF output to generate the first enhanced chroma ALF output (S906).

The video encoding device inputs the luma ALF output into the linear CC-ALF to generate the corrected values of the chroma component (S908).

The video encoding device may generate the corrected values based on a product of the luma samples within the target region to filter and the filter coefficients of the linear CC-ALF.

The video encoding device sums the corrected values of the chroma components and the chroma ALF output to generate a second enhanced chroma ALF output (S910).

Based on the chroma ALF output, the first enhanced chroma ALF output, and the second enhanced chroma ALF output, the video encoding device determines a CC-ALF flag (S912). Here, the CC-ALF flag indicates whether or not the linear CC-ALF is applied.

In terms of rate-distortion optimization, the video encoding device may determine the CC-ALF flag. For example, if the chroma ALF output is optimal, the video encoding device may set the CC-ALF flag to false. On the other hand, if the first enhanced chroma ALF output or the second enhanced chroma ALF output is optimal, the video encoding device may set the CC-ALF flag to true.

The video encoding device encodes the CC-ALF flag (S914).

The video encoding device checks the CC-ALF flag (S916).

If the CC-ALF flag is true (Yes in S916), the video encoding device determines a nonlinear CC-ALF flag based on the first enhanced chroma ALF output and the second enhanced chroma ALF output (S918).

In terms of rate-distortion optimization, the video encoding device may determine the nonlinear CC-ALF flag. For example, if the first enhanced chroma ALF output is optimal, the video encoding device may set the nonlinear CC-ALF flag to true. On the other hand, if the second enhanced chroma ALF output is optimal, the video encoding device may set the nonlinear CC-ALF flag to false.

The video encoding device encodes the nonlinear CC-ALF flag (S920).

If the CC-ALF flag is false (No in S916), the video encoding device may omit the steps (S918 and S920) of determining the nonlinear CC-ALF flag and encoding the nonlinear CC-ALF flag.

FIG. 10 is a flowchart of a method of filtering reconstructed frames by the video decoding device, according to at least one embodiment of the present disclosure.

The example of FIG. 10 depicts a case where both the ALF flag and the CC-ALF flag are true.

The video decoding device obtains the reconstructed frame (S1000). Here, the reconstructed frame is the output of the SAO filter 564.

The video decoding device inputs the reconstructed frame into the ALF to generate an ALF output (S1002). Here, the ALF output includes a luma ALF output and a chroma ALF output.

The video decoding device decodes a nonlinear CC-ALF flag from the bitstream (S1004). Here, the nonlinear CC-ALF flag indicates whether nonlinear CC-ALF is enabled or disabled.

The video decoding device checks the nonlinear ALF flag (S1006).

If the nonlinear ALF flag is true (Yes in S1006), the video decoding device performs the following steps (S1008 and S1010).

The video decoding device inputs the luma ALF output into the nonlinear CC-ALF to generate corrected values of the chroma component (S1008).

The video decoding device generates nonlinear modeled values of the luma samples by using a nonlinear model with respect to the luma samples within the target region to filter. The video decoding device may then generate the corrected values based on a product of the nonlinear modeled values and the filter coefficients of the nonlinear CC-ALF.

The video decoding device sums the corrected values of the chroma component and the chroma ALF output to generate an enhanced chroma ALF output (S1010).

On the other hand, if the nonlinear ALF flag is false (No in S1006), the video decoding device inputs the luma ALF output into the linear CC-ALF to generate the corrected values of the chroma component (S1020).

The video decoding device may generate the corrected values based on a product of the luma samples within the target region to filter and the filter coefficients of the linear CC-ALF 702.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

180: loop filter unit
186: ALF
560: loop filter unit
566: ALF
702: CC-ALF

1. A method of filtering a reconstructed frame by a video decoding device, the method comprising:
obtaining the reconstructed frame that is an output of a sample adaptive offset (SAO) filter;
generating an adaptive loop filter output (ALF output) by inputting the reconstructed frame into an adaptive loop filter (ALF), the ALF output including a luma ALF output and a chroma ALF output;
generating corrected values of a chroma component by inputting the luma ALF output into a nonlinear cross-component ALF (nonlinear CC-ALF); and
generating an enhanced chroma ALF output by summing the corrected values of the chroma component and the chroma ALF output.

2. The method of claim 1, further comprising:
decoding, from a bitstream, a nonlinear CC-ALF flag that indicates whether the nonlinear CC-ALF is enabled or disabled; and
checking the nonlinear CC-ALF flag,
wherein, when the nonlinear CC-ALF flag is true, proceeding with generating the corrected values of the chroma components and generating the enhanced chroma ALF output.

3. The method of claim 2, further comprising, when the nonlinear CC-ALF flag is false:
generating the corrected values of the chroma component by inputting the luma ALF output into a linear cross-component ALF (linear CC-ALF).

4. The method of claim 1, wherein the nonlinear CC-ALF is applied at a level common to a linear CC-ALF and the ALF, the level being a level of sequence, picture, sub-picture, slice, tile, and/or coding tree unit (CTU).

5. The method of claim 1, wherein generating the corrected values of the chroma component comprises:
generating the corrected values of the chroma component,
generating nonlinear modeled values of the luma samples by using a nonlinear model with respect to luma samples within a target region to filter; and
generating the corrected values based on a product between the nonlinear modeled values and filter coefficients of the nonlinear CC-ALF.

6. The method of claim 5, wherein the nonlinear model comprises:
a polynomial model, a hyperbolic model, a model based on a Fourier transform, or an exponential function model.

7. The method of claim 5, wherein the nonlinear CC-ALF has a diamond-shaped luma region of size 3×4 as the target region to filter.

8. The method of claim 1, wherein the nonlinear CC-ALF when applied to 4:2:2 and 4:4:4 chroma formats, is not applied to samples in a third row and a fourth row above a coding tree unit (CTU) boundary.

9. The method of claim 1, wherein the nonlinear CC-ALF has filter coefficients that are either transmitted in a form of an adaptation parameter set (APS) from a video encoding device or are predefined values.

10. The method of claim 5, further comprising:
decoding coefficients of the nonlinear model from a bitstream.

11. The method of claim 10, wherein generating the corrected values of the chroma component comprises:
adaptively using the nonlinear CC-ALF and the linear CC-ALF, but changing the nonlinear CC-ALF to the linear CC-ALF by setting to zero coefficients of the nonlinear model that are not related to the linear CC-ALF.

12. A method of filtering a reconstructed frame by a video encoding device, the method comprising:
obtaining the reconstructed frame that is an output of a sample adaptive offset (SAO) filter;
generating an adaptive loop filter output (ALF output) by inputting the reconstructed frame into an adaptive loop filter (ALF), the ALF output including a luma ALF output and a chroma ALF output;
generating corrected values of a chroma component by inputting the luma ALF output into a nonlinear cross-component ALF (nonlinear CC-ALF); and
generating a first enhanced chroma ALF output by summing the corrected values of the chroma component and the chroma ALF output.

13. The method of claim 12, further comprising:
generating corrected values of a chroma component by inputting the luma ALF output into a linear cross-component ALF (linear CC-ALF); and
generating a second enhanced chroma ALF output by summing the corrected values of the chroma component and the chroma ALF output.

14. The method of claim 13, further comprising:
determining a CC-ALF flag that indicates whether or not the linear CC-ALF is applied, based on the chroma ALF output, the first enhanced chroma ALF output, and the second enhanced chroma ALF output; and
encoding the CC-ALF flag.

15. The method of claim 14, further comprising:
checking the CC-ALF flag,
wherein, when the CC-ALF flag is true, determining a nonlinear CC-ALF flag based on the first enhanced chroma ALF output and the second enhanced chroma ALF output; and
encoding the nonlinear CC-ALF flag.

16. A computer-readable recording medium storing a bitstream generated by a video encoding method, the video encoding method comprises:
obtaining a reconstructed frame that is an output of a sample adaptive offset (SAO) filter;
generating an adaptive loop filter output (ALF output) by inputting the reconstructed frame into an adaptive loop filter (ALF), the ALF output including a luma ALF output and a chroma ALF output;
generating corrected values of a chroma component by inputting the luma ALF output into a nonlinear cross-component ALF (nonlinear CC-ALF); and
generating an enhanced chroma ALF output by summing the corrected values of the chroma component and the chroma ALF output.
